(19) United States
(12) Patent Application Publication
(10) Pub. No.: US 2006/0040202 A1
(43) Pub. Date: Feb. 23, 2006

(54) Positive working photosensitive composition

(75) Inventor: Isao Yahagi, Tsuchiura-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/694,721

(22) Filed: Oct. 29, 2003

(30) Foreign Application Priority Data
Oct. 31, 2002 (JP) 2002-317739
Jun. 30, 2003 (JP) 2003-186616

(51) Int. Cl. G03C 1/76

(52) U.S. Cl. 430/270.1

(57) ABSTRACT

A positive working photosensitive composition comprising an epoxy compound having two or more epoxy groups in one molecule, a curing catalyst or a compound for producing a curing catalyst by heat, and sulfonates, a method of manufacturing a member for a semiconductor comprising the steps of applying the positive working photosensitive composition on a substrate to expose, curing an unexposed part by heat, and developing an exposed part, and a method of manufacturing a member for a display comprising the steps of applying the positive working photosensitive composition on a substrate to expose, curing an unexposed part by heat, and developing an exposed part.

### FIELD OF THE INVENTION

The present invention relates to a positive working photosensitive composition.

### BACKGROUND OF THE INVENTION

The performance with high-speed, multi-functionalization and downsizing have been required for semiconductor devices mounted on cell phones, portable apparatuses, and the like. The wafer level packaging, therefore, has been studied such that a chip is packaged in a state of a wafer.

In the wafer level packaging, a chip and a wafer are joined up by the solder bump, and in order to secure the reliability of devices, it is necessary to fill in gaps formed between the chip and the wafer with an underfill agent.

The epoxy resin is suitable as the underfill agent; however, it is necessary to inject the underfill agent into the every gap between the chip and the wafer.

Accordingly, a positive working photosensitive composition has been expectantly developed which can be dissolved and removed by exposure except for the underfill agent injected into the gaps.

For example, a composition comprising epoxy resin, amine curing agent, halogen acid anhydride and halogenated hydrocarbon solvent is known as the positive type photosensitive composition (JP48-15059 A). However the halogenated hydrocarbon solvent tends to generate voids to easily enter in injecting the composition into the gaps to cure.

The object of the present invention is to provide a positive working photosensitive composition usable for the underfill agent.

### SUMMARY OF THE INVENTION

Through earnest studies for finding out a positive working photosensitive composition, the inventors of the present invention have completed the present invention by finding out that a composition comprising an epoxy compound having two or more epoxy groups in one molecule, a curing catalyst or a compound for producing a curing catalyst by heat, and sulfonates offers positive working photosensitivity and is usable for an underfill agent.

That is, the present invention provides a positive working photosensitive composition comprising an epoxy compound having two or more epoxy groups in one molecule, a curing catalyst or a compound for producing a curing catalyst by heat, and sulfonates.

### DETAILED DESCRIPTION OF THE PRESENT INVENTION

A positive working photosensitive composition of the present invention comprises an epoxy compound having two or more epoxy groups in one molecule, a curing catalyst or a compound for producing a curing catalyst by heat, and sulfonates.

An epoxy compound employed in the present invention is at least one selected from the group consisting of a monomer having two or more epoxy groups in one molecule and an epoxy resin having two or more epoxy groups in one molecule.

The monomer having two or more epoxy groups in one molecule involves bisphenol A diglycidyl ether, bisphenol F diglycidyl ether, bisphenol S diglycidyl ether, glycerol diglycidyl ether, tris(glycidyloxyphenyl)methane, and the like.

The epoxy resin having two or more epoxy groups in one molecule involves phenol novolac type epoxy resin, cresol novolac type epoxy resin, biphenyl type epoxy resin, biphenyl novolac type epoxy resin, and the like.

The preferable epoxy compound employed in the present invention is a monomer having two or more epoxy groups in one molecule or an epoxy resin having two or more epoxy groups in one molecule, both of which show fluidity around room temperature by heating.

A liquid monomer at temperature having two or more epoxy groups in one molecule is more preferable in view of workability.

A curing catalyst or a compound for producing a curing catalyst by heat employed in the present invention is not particularly limited on the condition that the catalyst or the compound can polymerize an epoxy compound having two or more epoxy groups in one molecule to form an epoxy resin. Also, in the case where an epoxy compound employed in the present invention is an epoxy resin, the catalyst provides an epoxy resin having higher molecular weight.

The curing catalyst involves amine compound, organic phosphine compound, and the like; amine compound is preferable.

The amine compound involves tertiary amine, quaternary ammonium salt, imidazoles, and the like.

The tertiary amine involves tributylamine, triethylamine, 1,8-diazabicyclo(5,4,0)undecen-7, triamylamine, and the like.

The quaternary ammonium salt involves benzyltrimethylammonium chloride, benzyltrimethylammonium hydroxide, triethylammonium tetraphenylborate, and the like.

The imidazoles involve 2-ethylimidazole, 2-ethyl-4-methylimidazole, and the like.

The organic phosphine compound involves trialkylphosphine, tetraphenylborate of trialkylphosphine, and the like.

The trialkylphosphine involves triphenylphosphine, tri-4-methylphenylphosphine, tri-4-methoxyphenylphosphine, tributylphosphine, trioctylphosphine, tri-2-cyanoethylphosphine, and the like.

The compound for producing a curing catalyst by heat involves thermal cationic curing catalyst, thermal base generating agent, and the like.

The thermal cationic curing catalyst involves iodonium salt, sulfonium salt, and phosphate of any one of boron, arsenic, antimony, phosphorus, and the like.

The example involves RHODOSIL 2074, ADEKA OPTMER SP-150, ADEKA OPTMER SP-152, ADEKA OPTMER SP-170, ADEKA OPTMER SP-172, ADEKA OPTON CP SERIES, and the like.

The thermal base generating agent involves
N-(2-nitrobenzyloxycarbonyl)imidazole,
N-(3-nitrobenzyloxycarbonyl)imidazole,
N-(4-nitrobenzyloxycarbonyl)imidazole,
N-(5-methyl-2-nitrobenzyloxycarbonyl)imidazole,
N-(4-chloro-2-nitrobenzyloxycarbonyl) imidazole, and the like.

The mixture ratio of the epoxy compound and the curing catalyst is not particularly limited, and is preferably 100:0.1 to 100: 10 from the view where the mixture at such a ratio provides the shorter gel time of the composition, such as 1 to 15 minutes at the predetermined temperature of 80 to 250° C.

Sulfonates employed in the present invention are photo-acid generating agents by electromagnetic rays for producing a species deactivating a curing catalyst.

Here, the electromagnetic rays typically mean ultraviolet lights, electronic rays and X rays.

The sulfonates involve a compound represented in the following formulae (1) to (7), and a mixture of these compounds.

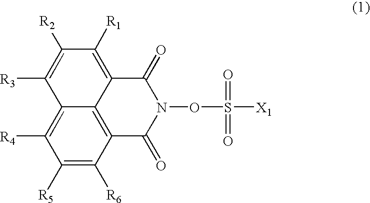

In the formula, X₁ is an optionally substituted monovalent organic group with a carbon number of 1 to 20. R₁ to R₆ are each independently a hydrogen atom or a monovalent organic group.

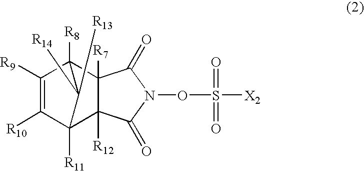

In the formula, X₂ is an optionally substituted monovalent organic group with a carbon number of 1 to 20. R₇ to R₁₄ are each independently a hydrogen atom or a monovalent organic group.

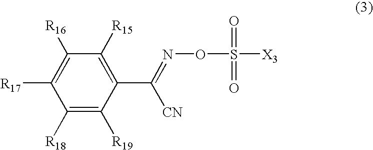

In the formula, X₃ is an optionally substituted monovalent organic group with a carbon number of 1 to 20. R₁₅ to R₁₉ are each independently a hydrogen atom, an alkoxy group or a monovalent organic group.

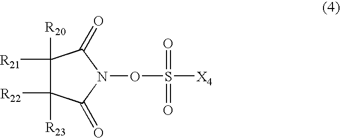

In the formula, X₄ is an optionally substituted monovalent organic group with a carbon number of 1 to 20. R₂₀ to R₂₃ are each independently a hydrogen atom or a monovalent organic group.

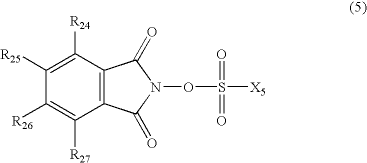

In the formula, X₅ is an optionally substituted monovalent organic group. R₂₄ to R₂₇ are each independently a hydrogen atom or a monovalent organic group.

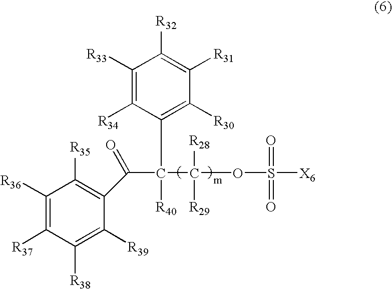

In the formula, X₆ is an optionally substituted monovalent organic group. R₂₈ to R₃₉ are each independently a hydrogen atom or a monovalent organic group. R₄₀ is a hydrogen atom or a hydroxyl group. m is 0 or 1.

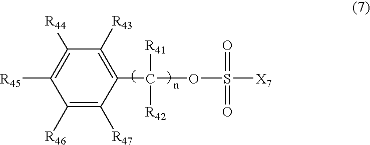

In the formula, X₇ is an optionally substituted monovalent organic group. R₄₁ and R₄₂ are each independently a hydrogen atom or a monovalent organic group with a carbon number of 1 to 20. R₄₃ to R₄₇ are each independently a hydrogen atom, a nitro group or a monovalent organic group. n is 0 or 1.

In the formulae (1) to (7), a monovalent organic group involves a linear aliphatic hydrocarbon group with a carbon number of 1 to 20, a branched aliphatic hydrocarbon group with a carbon number of 3 to 20, a cyclic aliphatic hydrocarbon group with a carbon number of 3 to 20, an aromatic hydrocarbon group with a carbon number of 6 to 20, a linear aliphatic hydrocarbon group with a carbon number of 1 to 20 substituted with a fluorine atom, a branched aliphatic hydrocarbon group with a carbon number of 3 to 20 substituted with a fluorine atom, a cyclic aliphatic hydrocarbon group with a carbon number of 3 to 20 substituted with a fluorine atom, an aromatic hydrocarbon group with a carbon number of 6 to 20 substituted with a fluorine atom, an alkyl group or an alkyl group substituted with a fluorine atom, and the like.

Among these, the following are preferable: a linear hydrocarbon group with a carbon number of 1 to 6, a branched hydrocarbon group with a carbon number of 3 to 6, a cyclic hydrocarbon group with a carbon number of 3 to 6, an aromatic hydrocarbon group with a carbon number of 6 to 20 substituted with an alkyl group, a linear hydrocarbon group with a carbon number of 1 to 6 substituted with a fluorine atom, a branched hydrocarbon group with a carbon number of 3 to 6 substituted with a fluorine atom, a cyclic hydrocarbon group with a carbon number of 3 to 6 substituted with a fluorine atom, and an aromatic hydrocarbon group with a carbon number of 6 to 20 substituted with an alkyl group substituted with a fluorine atom.

The linear aliphatic hydrocarbon group with a carbon number of 1 to 20 involves a methyl group, an ethyl group, a propyl group, a butyl group, a pentyl group, a hexyl group, and the like.

The branched aliphatic hydrocarbon group with a carbon number of 3 to 20 involves an isopropyl group, an isobutyl group, a tert-butyl group, and the like.

The cyclic aliphatic hydrocarbon group with a carbon number of 3 to 20 involves a cyclopropyl group, a cyclobutyl group, a cyclopentyl group, a cyclohexyl group, and the like.

The aromatic hydrocarbon group with a carbon number of 6 to 20 optionally substituted with an alkyl group involves a phenyl group, a naphthyl group, an anthryl group, a tolyl group, a xylyl group, a dimethylphenyl group, a trimethylphenyl group, an ethylphenyl group, a diethylphenyl group, a triethylphenyl group, a propylphenyl group, a butylphenyl group, a methylnaphthyl group, a dimethylnaphthyl group, a trimethylnaphthyl group, a vinylnaphthyl group, a ethenylnaphthyl group, a methylanthryl group, an ethylanthryl group, and the like.

The alkyl group as a substituent involves an alkyl group with a carbon number of 1 to 6 such as a methyl group, an ethyl group, a propyl group, a butyl group, a pentyl group, a hexyl group, anisopropyl group, an isobutyl group, atert-butyl group, a cyclopropyl group, a cyclobutyl group, a cyclopentyl group, and a cyclohexyl group.

The linear aliphatic hydrocarbon group with a carbon number of 1 to 20 substituted with a fluorine atom involves a trifluoromethyl group, a difluoromethyl group, a fluoromethyl group, a pentafluoroethyl group, a tetrafluoroethyl group, a trifluoroethyl group, a difluoroethyl group, a fluoroethyl group, a heptafluoropropyl group, a hexafluoropropyl group, a pentafluoropropyl group, a tetrafluoropropyl group, and the like.

The branched aliphatic hydrocarbon group with a carbon number of 3 to 20 substituted with a fluorine atom involves a hexafluoroisopropyl group, an octafluoroisobutyl group, a nonafluorotert-butyl group, and the like.

The cyclicaliphatic hydrocarbon group with a carbon number of 3 to 20 substituted with a fluorine atom involves a pentafluorocyclopropyl group, a heptafluorocyclobutyl group, a nonafluorocyclopentyl group, and the like.

The alkyl group substituted with a fluorine atom as a substituent involves a trifluoromethyl group, a difluoromethyl group, a fluoromethyl group, a pentafluoroethyl group, a tetrafluoroethyl group, a trifluoroethyl group, a difluoroethyl group, a fluoroethyl group, a heptafluoropropyl group, a hexafluoropropyl group, a pentafluoropropyl group, a tetrafluoropropyl group, and the like.

The aromatic hydrocarbon group with a carbon number of 6 to 20 substituted with an alkyl group substituted with a fluorine atom involves a trifluoromethylphenyl group, a nonafluorobutylphenyl group, and the like.

In the formula (3), an alkoxy group involves a methoxy group, ethoxy group, and the like, and a methoxy group is preferable.

Preferable sulfonates are as follows.

The sulfonates represented in the formula (1) involve a sulfonate in which R₁ to R₆ are hydrogen atoms and X₁ is a methyl group, a sulfonate in which R₁ to R₆ are hydrogen atoms and X₁ is an ethyl group, a sulfonate in which R₁ to R₆ are hydrogen atoms and X₁ is a propyl group, a sulfonate in which R₁ to R₆ are hydrogen atoms and X₁ is a butyl group, a sulfonate in which R₁ to R₆ are hydrogen atoms and X₁ is a tolyl group, a sulfonate in which R₁ to R₆ are hydrogen atoms and X₁ is a trifluoromethyl group, a sulfonate in which R₁ to R₆ are hydrogen atoms and X₁ is a camphor group, a sulfonate in which R₁ to R₆ are hydrogen atoms and X₁ is a nonafluorobutyl group, and the like.

The sulfonates represented in the formula (2) involve a sulfonate in which R₇ to R₁₄ are hydrogen atoms and X₂ is a tolyl group, a sulfonate in which R₇ to R₁₄ are hydrogen atoms and X₂ is a trifluoromethyl group, a sulfonate in which R₇ to R₁₄ are hydrogen atoms and X₂ is a camphor group, a sulfonate in which R₇ to R₁₄ are hydrogen atoms and X₂ is a nonafluorobutyl group, and the like.

The sulfonates represented in the formula (3) involve a sulfonate in which R₁₅ to R₁₉ are hydrogen atoms and X₃ is a tolyl group, a sulfonate in which R₁₅, R₁₆, R₁₈ and R₁₉ are hydrogen atoms, R₁₇ is a methoxy group and X₃ is a tolyl group, a sulfonate in which R₁₅, R₁₆, R₁₈ and R₁₉ are hydrogen atoms, R₁₇ is a methoxy group and X₃ is a camphor group, a sulfonate in which R₁₅, R₁₆, R₁₈ and R₁₉ are hydrogen atoms, R₁₇ is a methoxy group and X₃ is a methyl group, and the like.

The sulfonates represented in the formula (4) involve a sulfonate in which R₂₀ to R₂₃ are hydrogen atoms and X₄ is a tolyl group, a sulfonate in which R₂₀ to R₂₃ are hydrogen atoms and X₄ is a trifluoromethyl group, a sulfonate in which R₂₀ to R₂₃ are hydrogen atoms and X₄ is a camphor group, a sulfonate in which R₂₀ to R₂₃ are hydrogen atoms and X₄ is a nonafluorobutyl group, and the like.

The sulfonates represented in the formula (5) involve a sulfonate in which R₂₄ to R₂₇ are hydrogen atoms and X₅ is a trifluoromethyl group, a sulfonate in which R₂₄ to R₂₇ are hydrogen atoms and X₅ is a camphor group, a sulfonate in which R₂₄ to R₂₇ are hydrogen atoms and X₅ is a nonafluorobutyl group, and the like.

The sulfonates represented in the formula (6) involve a sulfonate in which m is 0, R₃₀ to R₄₀ are hydrogen atoms and X₆ is a tolyl group, a sulfonate in which m is 1, R₂₈ to R₃₉ are hydrogen atoms, R₄₀ is a hydroxyl group and X₆ is a tolyl group, a sulfonate in which m is 1, R₂₈ to R₃₁, R₃₃ to R₃₆, R₃₈ and R₃₉ are hydrogen atoms, R₄₀ is a hydroxyl group, R₃₂ and R₃₇ are methoxy groups and X₆ is a tolyl group, a sulfonate in which m is 1, R₂₈ to R₃₁, R₃₃ to R₃₆, R₃₈ and R₃₉ are hydrogen atoms, R₄₀ is a hydroxyl group, R₃₂ and R₃₇ are thiomethyl groups and X₆ is a tolyl group, and the like.

The sulfonates represented in the formula (7) involve a sulfonate in which n is 0, R₄₃ to R₄₇ are hydrogen atoms and X₇ is a methyl group, a sulfonate in which n is 1, R₄₁, R₄₂ and R₄₄ to R₄₆ are hydrogen atoms, R₄₃ and R₄₇ are nitro groups and X₇ is a tolyl group, a sulfonate in which n is 1, R₄₁, R₄₂ and R₄₄ to R₄₇ are hydrogen atoms, R₄₃ is a nitro group and X₇ is a tolyl group, a sulfonate in which n is 1, R₄₁ to R₄₄, R₄₆ and R₄₇ are hydrogen atoms, R₄₅ is a nitro group and X₇ is a tolyl group, and the like.

The sulfonates are preferably added to the curing catalyst by an equivalent amount of 0.1 to 5 thereto, more preferably an equivalent amount of 0.5 to 3.

The addition of the sulfonates by an equivalent amount of less than 0.1 may insufficiently deactivate the curing catalyst, while the addition thereof by an equivalent amount of more than 5 may not have sufficient effect of deactivating the curing catalyst correspondingly to the quantity of addition.

An epoxy resin curing agent may be added to a positive working photosensitive composition of the present invention, and the curing agent involves a phenol curing agent, an amine curing agent, an acid anhydride curing agent, or a mixture of these curing agents, or the like. Among these, an acid anhydride is preferably used from the viewpoint of workability, and an acid anhydride having a viscosity of 100 to 5000 centipoises at a temperature of 25° C. is more preferably used.

The phenol curing agent involves phenol novolac, tert-butylphenol novolac, tert-butylcathecol, bisphenol A, bisphenol F, biphenol, and the like.

The amine curing agent involves dicyandiamide, diaminodiphenyl methane, diaminodiphenyl sulfone, and the like.

The acid anhydride curing agent involves phthalic anhydride, trimellitic anhydride, pyromellitic anhydride, benzophenone tetracarboxylic anhydride, glycerol tris anhydride trimellitate, methyltetrahydrophthalic anhydride, methylnadic anhydride, and the like.

The mixture ratio of the epoxy resin and curing agent is not particularly limited, and is typically an equivalent amount of 0.8 to 1.0 with respect to the equivalent amount of an epoxy group.

Also, a sensitizer may be added to a positive working photosensitive composition of the present invention as required.

The sensitizer involves ADEKA OPTMER SP-100, and the like.

A positive working photosensitive composition of the present invention can be prepared by mixing each of the above-mentioned components in an arbitrary order.

In the case of mixing a curing catalyst or a compound for producing the curing catalyst by heat, a photo-acid generating agent and a sensitizer, a minimum necessary solvent may be added thereto. The solvent involves acetone, tetrahydrofuran, methyl ethyl ketone, and the like.

Next, a method of manufacturing members for semiconductors or members for displays by using a positive working photosensitive composition of the present invention is described.

First, a positive working photosensitive composition of the present invention is applied on the whole or partial surface of a substrate. A method of applying involves bar coater, roll coater, die coater, spin coater, and the like.

After applying, the exposure is performed by using an exposure device. The exposure device involves a proximity exposure machine, and the like.

In the case of exposing in a large area, the exposure is performed while moving an exposure machine after applying the photosensitive composition on the substrate, so that the exposure machine with a small area of exposure can expose in a large area. Rays used for exposing involve ultraviolet lights, and the like.

A curing catalyst in the exposed part is deactivated by sulfonates through the exposure.

After exposing, the positive working photosensitive composition in the unexposed part is cured by heat-treating the substrate to be thereafter developed.

The heat treatment is preferably performed at the decomposition temperature or less of the sulfonates. The heat treatment at more than the decomposition temperature of the sulfonates may not cure in the unexposed part.

The development is usually performed by an immersing method, a spraying method, a brushing method, and the like.

The developer is not particularly limited if it can dissolve the uncured positive working photosensitive composition, and involves acetone, methyl isobutyl ketone, tetrahydrofuran, propylene glycol monomethyl ether acetate, and the like.

Members for semiconductors or members for displays can be manufactured by thus forming a cured product of the positive working photosensitive composition in the unexposed part.

The positive working photosensitive composition of the present invention can be appropriately used as an underfill agent for filling in gaps for the reason that the composition injected into the gaps formed between a chip and a wafer with regard to the wafer-level package is not exposed so as to be cured by heat-treating.

### EXAMPLES

The present invention is hereinafter described on the basis of examples, and it is apparent that the present invention is not limited to the examples.

### Example 1

1.34 g of bisphenol A diglycidyl ether (manufactured by TOHTO KASEI CO., LTD.), 0.33 g of novolac resin (a phenol equivalent amount of 106), 0.0067 g of 3-nitrobenzyloxycarbonylimidazole and 0.0179 g of a photo-acid generating agent (8) were dissolved in acetone to prepare a uniform resist solution, and the solution was concentrated under a reduced pressure to obtain a viscous positive working photosensitive liquid sealing agent.

The curing behavior of the obtained positive working photosensitive liquid sealing agent was measured at a temperature of 130° C. by using a cone-plate viscometer (manufactured by MST ENGINEERING CO., LTD.). The unexposed positive working photosensitive liquid sealing agent was gelated in 22 minutes.

The obtained positive working photosensitive liquid sealing agent was exposed at 1000 mJ/cm² by using a proximity exposure machine (MAP-1300, manufactured by DAINIPPON SCREEN MFG. CO., LTD.) to measure the curing behavior thereof at a temperature of 130° C. by using a cone plate viscometer (manufactured by MST ENGINEERING CO., LTD.). The positive working photosensitive liquid sealing agent was not gelated in 35 minutes.

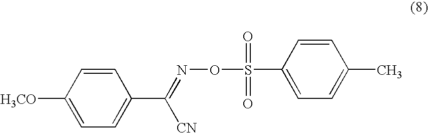

### Example 2

31.12 g of bisphenol A diglycidyl ether (manufactured by TOHTO KASEI CO., LTD.), 0.338 g of a photo-acid generating agent (8) and 0.068 g of ADEKA OPTMER SP-100 (manufactured by ASAHI DENKA CO., LTD.) were dissolved in acetone to prepare a uniform solution, and the solution was concentrated under a reduced pressure to obtain a viscous composition.

23.32 g of methyl-5-norbornane-2,3-dicarboxylic anhydride (manufactured by WAKO PURE CHEMICAL INDUSTRIES, LTD.) and 0.16 g of 1,8-diazabicyclo[5,4,0]-unde-7-ene (manufactured by SIGMA-ALDRICH CORPORATION) were added to the obtained composition to obtain a uniform positive working photosensitive liquid sealing agent by a stirring defoaming apparatus (HM-500 manufactured by KEYENCE CORPORATION).

The curing behavior of the obtained positive working photosensitive liquid sealing agent was measured at a temperature of 130° C. by using a cone plate viscometer (manufactured by MST ENGINEERING CO., LTD.). The unexposed positive working photosensitive liquid sealing agent was gelated in 20 minutes.

The obtained positive working photosensitive liquid sealing agent was exposed at 1000 mJ/cm² by using a proximity exposure machine (MAP-1300, manufactured by DAINIPPON SCREEN MFG. CO., LTD.) to measure the curing behavior thereof at a temperature of 130° C. by using a cone plate viscometer (manufactured by MST ENGINEERING CO., LTD.). The gelation time thereof was 26 minutes.

### Comparative Example 1

1.34 g of bisphenol A diglycidyl ether (manufactured by TOHTO KASEI CO., LTD.), 0.33 g of novolac resin (a phenol equivalent amount of 106), 0.0067 g of 3-nitrobenzyloxycarbonylimidazole, 0.0182 g of a photo-acid generating agent (9) and 0.0036 g of ADEKA OPTMER SP-100 were dissolved in acetone to prepare a uniform solution, and the solution was concentrated under a reduced pressure to obtain a viscous positive working photosensitive liquid sealing agent.

The curing behavior of the obtained positive working photosensitive liquid sealing agent was measured at a temperature of 130° C. by using a cone plate viscometer (manufactured by MST ENGINEERING CO., LTD.). The unexposed positive working, photosensitive liquid sealing agent was not gelated in 25 minutes.

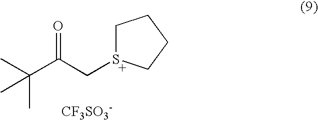

### Comparative Example 2

1.34 g of bisphenol A diglycidyl ether (manufactured by TOHTO KASEI CO., LTD.), 0.33 g of novolac resin (a phenol equivalent amount of 106), 0.0067 g of 3-nitrobenzyloxycarbonylimidazole and 0.0193 g of a photo-acid generating agent (10) were dissolved in acetone to prepare a uniform solution, and the solution was concentrated under a reduced pressure to obtain a viscous positive working photosensitive liquid sealing agent.

The curing behavior of the obtained positive working photosensitive liquid sealing agent was measured at a temperature of 130° C. by using a cone plate viscometer (manufactured by MST ENGINEERING CO., LTD.). The unexposed positive working photosensitive liquid sealing agent was not gelated in 33 minutes.

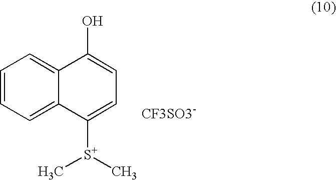

### Comparative Example 3

1.34 g of bisphenol A diglycidyl ether (manufactured by TOHTO KASEI CO., LTD.), 0.33 g of novolac resin (a phenol equivalent amount of 106), 0.0067 g of 3-nitrobenzyloxycarbonylimidazole and 0.0202 g of a photo-acid generating agent (11) were dissolved in acetone to prepare a uniform solution, and the solution was concentrated under a reduced pressure to obtain a viscous positive working photosensitive liquid sealing agent.

The curing behavior of the obtained positive working photosensitive liquid sealing agent was measured at a temperature of 130° C. by using a cone plate viscometer (manufactured by MST ENGINEERING CO., LTD.). The unexposed positive working photosensitive liquid sealing agent was not gelated in 33 minutes.

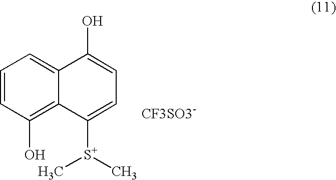

The present invention can provide a positive working photosensitive composition usable as an underfill agent.

What is claimed is:

1. A positive working photosensitive composition comprising:
an epoxy compound having two or more epoxy groups in one molecule;
a curing catalyst or a compound for producing a curing catalyst by heat; and
sulfonates.

2. A composition according to claim 1, wherein the sulfonates are at least one compound selected from the group consisting of a compound represented in the following formulae (1) to (7), 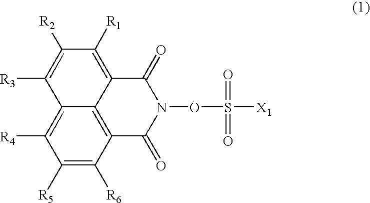
wherein X₁ is an optionally substituted monovalent organic group with a carbon number of 1 to 20, and R₁ to R₆ are each independently a hydrogen atom or a monovalent organic group, 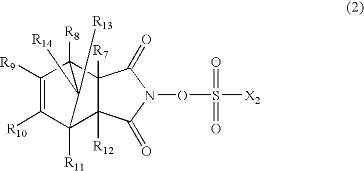
wherein X₂ is an optionally substituted monovalent organic group with a carbon number of 1 to 20, and R₇ to R₁₄ are each independently a hydrogen atom or a monovalent organic group, 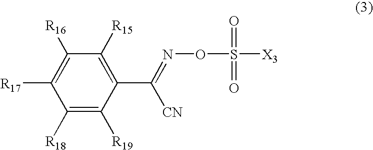
wherein X₃ is an optionally substituted monovalent organic group with a carbon number of 1 to 20, and R₁₅ to R₁₉ are each independently a hydrogen atom, an alkoxy group or a monovalent organic group, 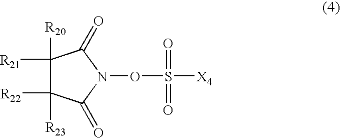
wherein X₄ is an optionally substituted monovalent organic group with a carbon number of 1 to 20, and R₂₀ to R₂₃ are each independently a hydrogen atom or a monovalent organic group, 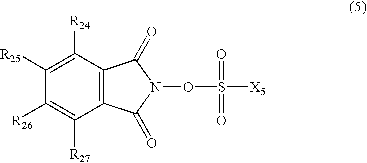
wherein X₅ is an optionally substituted monovalent organic group with a carbon number of 1 to 20, and R₂₄ to R₂₇ are each independently a hydrogen atom or a monovalent organic group, 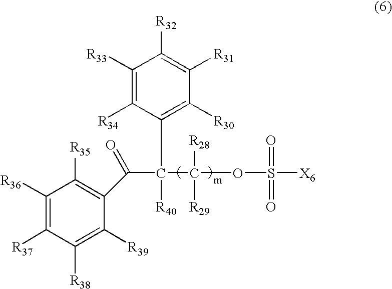
wherein X₆ is an optionally substituted monovalent organic group with a carbon number of 1 to 20, R₂₈ to R₃₉ are each independently a hydrogen atom or a monovalent organic group, R₄₀ is a hydrogen atom or a hydroxyl group, and m is 0 or 1, 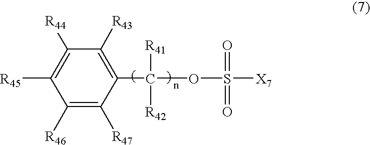
wherein X₇ is an optionally substituted monovalent organic group, R₄₁ and R₄₂ are each independently a hydrogen atom or a monovalent organic group with a carbon number of 1 to 20, R₄₃ to R₄₇ are each independently a hydrogen atom, a nitro group or a monovalent organic group with a carbon number of 1 to 20, and n is 0 or 1.

3. A method of manufacturing a member for a semiconductor comprising the steps of:
applying a positive working photosensitive composition according to claim 1 on a substrate to expose;
curing an unexposed part thereof by heat; and
developing an exposed part thereof.

4. A method of manufacturing a member for a display comprising the steps of:
applying a positive working photosensitive composition according to claim 1 on a substrate to expose;
curing an unexposed part thereof by heat; and
developing an exposed part thereof.
